(19) United States
(12) Patent Application Publication
(10) Pub. No.: US 2016/0131332 A1
(43) Pub. Date: May 12, 2016

(54) Method and System for Redirecting Light Emitted from a Light Emitting Diode

(71) Applicant: Kevin Charles Broughton, Sharpsburg, GA (US)

(72) Inventor: Kevin Charles Broughton, Sharpsburg, GA (US)

(21) Appl. No.: 14/952,703

(22) Filed: Nov. 25, 2015

Related U.S. Application Data
(63) Continuation of application No. 14/085,509, filed on Nov. 20, 2013, now Pat. No. 9,200,765.
(60) Provisional application No. 61/728,475, filed on Nov. 20, 2012.

(51) Int. Cl. F21V 7/00

(52) U.S. Cl. CPC F21V 7/0091; F21Y 2101/02

(57) ABSTRACT

A light source, for example a light emitting diode, can emit light and have an associated optical axis. The source can be deployed in applications where it is desirable to have illumination biased laterally relative to the optical axis, such as in a street luminaire where directing light towards the street is beneficial. The source can be coupled to an optic that comprises a cavity. A first region of the optic can receive light from the source and emit light towards the area to be illuminated. A second region of the optic can comprise two reflective surfaces. The first reflective surface can receive light from the source and reflect the received light towards the second reflective surface. The two reflective surfaces can be used to direct light away from one side of the optic.

### RELATED APPLICATIONS

This application is a continuation of and claims priority to U.S. patent application Ser. No. 14/085,509 filed on Nov. 20, 2013, and titled “Method and System For Redirecting Light Emitted From a Light Emitting Diode,” which claims priority under 35 U.S.C. Section 119 to U.S. Provisional Application No. 61/728,475, filed on Nov. 20, 2012, and titled “Method and System For Redirecting Light Emitted From a Light Emitting Diode.” The foregoing applications are incorporated herein in their entirety.

The present application is related to U.S. Non-Provisional application Ser. No. 13/828,670, filed on Mar. 14, 2013, and titled “Method and System For Managing Light From a Light Emitting Diode,” which is a continuation-in-part of and claims priority to U.S. Non-Provisional application Ser. No. 13/407,401, filed on Feb. 28, 2012, and titled “Method and System for Managing Light from a Light Emitting Diode.” The foregoing applications are incorporated herein in their entirety.

### FIELD OF THE TECHNOLOGY

The present technology relates to managing light emitted by one or more light emitting diodes (“LEDs”), and more specifically to optical elements that can apply successive reflections of the emitted light to redirect the light in a desired direction.

### BACKGROUND OF THE INVENTION

Light emitting diodes are useful for indoor and outdoor illumination, as well as other applications. Many such applications would benefit from an improved technology for managing light produced by a light emitting diode, such as forming an illumination pattern matched or tailored to application parameters.

For example, consider lighting a street running along a row of houses, with a sidewalk between the houses and the street. Conventional, unbiased light emitting diodes could be mounted over the sidewalk, facing down, so that the optical axis of an individual light emitting diode points towards the ground. In this configuration, the unbiased light emitting diode would cast substantially equal amounts of light towards the street and towards the houses. The light emitted from each side of the optical axis continues, whether headed towards the street or the houses. However, most such street lighting applications would benefit from biasing the amount of light illuminating the street relative to the amount of light illuminating the houses. Many street luminaires would thus benefit from a capability to transform house side light into street side light.

In view of the foregoing discussion of representative shortcomings in the art, need for improved light management is apparent. Need exists for a compact apparatus to manage light emitted by a light emitting diode. Need further exists for an economical apparatus to manage light emitted by a light emitting diode. Need further exists for a technology that can efficiently manage light emitted by a light emitting diode, resulting in energy conservation. Need further exists for an optical device that can transform light emanating from a light emitting diode into a desired pattern, for example aggressively redirecting one or more selected sections of the emanating light. Need further exists for technology that can directionally bias light emitted by a light emitting diode. Need exists for improved lighting, including street luminaires, outdoor lighting, and general illumination. A capability addressing such need, or some other related deficiency in the art, would support cost effective deployment of light emitting diodes in lighting and other applications.

### SUMMARY OF THE INVENTION

An apparatus can process light emitted by one or more light emitting diodes to form a desired illumination pattern, for example successively applying at least two total internal reflections to light headed in certain directions, resulting in beneficial redirection of that light.

In one aspect of the present technology, a light emitting diode can produce light and have an associated optical axis. A body of optical material can be oriented with respect to the light emitting diode to process the produced light. The body can be either seamless or formed from multiple elements joined or bonded together, for example. A first section of the produced light can transmit through the body of optical material, for example towards an area to be illuminated. The body of optical material can redirect a second section of the produced light, for example so that light headed in a non-strategic direction is redirected towards the area to be illuminated. A refractive surface on an interior side of the body of optical material can form a beam from the second section of the produced light or otherwise reduce divergence of that light. The beam can propagate in the optical material at an angle relative to the optical axis of the light emitting diode while heading towards a first reflective surface on an exterior side of the body of optical material. Upon beam incidence, the first reflective surface can redirect the beam to a second reflective surface on an exterior side of the body of optical material. The second reflective surface can redirect the beam across the optical axis outside the body and towards the area to be illuminated. Accordingly, the first and second reflective surfaces can collaboratively redirect light from a non-strategic direction to a strategic direction. One or both of the reflective surfaces can be reflective as a result of comprising an interface between a transparent optical material having a relatively high refractive index and an optical medium having relatively low refractive index, such as a totally internally reflective interface between optical plastic and air. Alternatively, one or both of the reflective surfaces can comprise a coating that is reflective, such as a sputtered aluminum coating applied to a region of the body of optical material.

The foregoing discussion of managing light is for illustrative purposes only. Various aspects of the present technology may be more clearly understood and appreciated from a review of the following detailed description of the disclosed embodiments and by reference to the drawings and the claims that follow. Moreover, other aspects, systems, methods, features, advantages, and objects of the present technology will become apparent to one with skill in the art upon examination of the following drawings and detailed description. It is intended that all such aspects, systems, methods, features, advantages, and objects are to be included within this description, are to be within the scope of the present technology, and are to be protected by the accompanying claims.

### BRIEF DESCRIPTION OF THE DRAWINGS

FIG. 1 is an illustration of an illumination system comprising a light emitting diode and an optic that manages light emitted by the light emitting diode according to certain exemplary embodiments of the present technology.

FIG. 2 is another illustration of the illumination system that FIG. 1 illustrates, with overlaid ray tracing according to certain exemplary embodiments of the present technology.

Many aspects of the technology can be better understood with reference to the above drawings. The elements and features shown in the drawings are not to scale, emphasis instead being placed upon clearly illustrating the principles of exemplary embodiments of the present technology. Moreover, certain dimensions may be exaggerated to help visually convey such principles. In the drawings, reference numerals designate like or corresponding, but not necessarily identical, elements throughout the several views.

### DESCRIPTION OF EXAMPLE EMBODIMENTS OF THE INVENTION

A light source can emit light. In certain embodiments, the light source can be or comprise one or more light emitting diodes, for example. The light source and/or the emitted light can have an associated optical axis. The light source can be deployed in applications where it is desirable to bias illumination laterally relative to the optical axis. For example, in a street luminaire where the optical axis is pointed down towards the ground, it may be beneficial to direct light towards the street side of the optical axis, rather than towards a row of houses that are beside the street. The light source can be coupled to an optic that receives light propagating on one side of the optical axis and redirects that light across the optical axis. For example, the optic can receive light that is headed towards the houses and redirect that light towards the street.

The optic can comprise an inner surface facing the light source and an outer surface facing away from the light source, opposite the inner surface. The inner surface can form a cavity that receives light emitted by the light source. The outer surface can comprise a protrusion or projection that reflects light at least two times and that redirects light across the optical axis. Accordingly, the optic can transform light headed in a non-strategic direction to light headed a strategic direction.

The present technology can be embodied in many different forms and should not be construed as limited to the embodiments set forth herein; rather, these embodiments are provided so that this disclosure will be thorough and complete, and will fully convey the scope of the technology to those having ordinary skill in the art. Furthermore, all “examples” or “exemplary embodiments” given herein are intended to be non-limiting and among others supported by representations of the present technology.

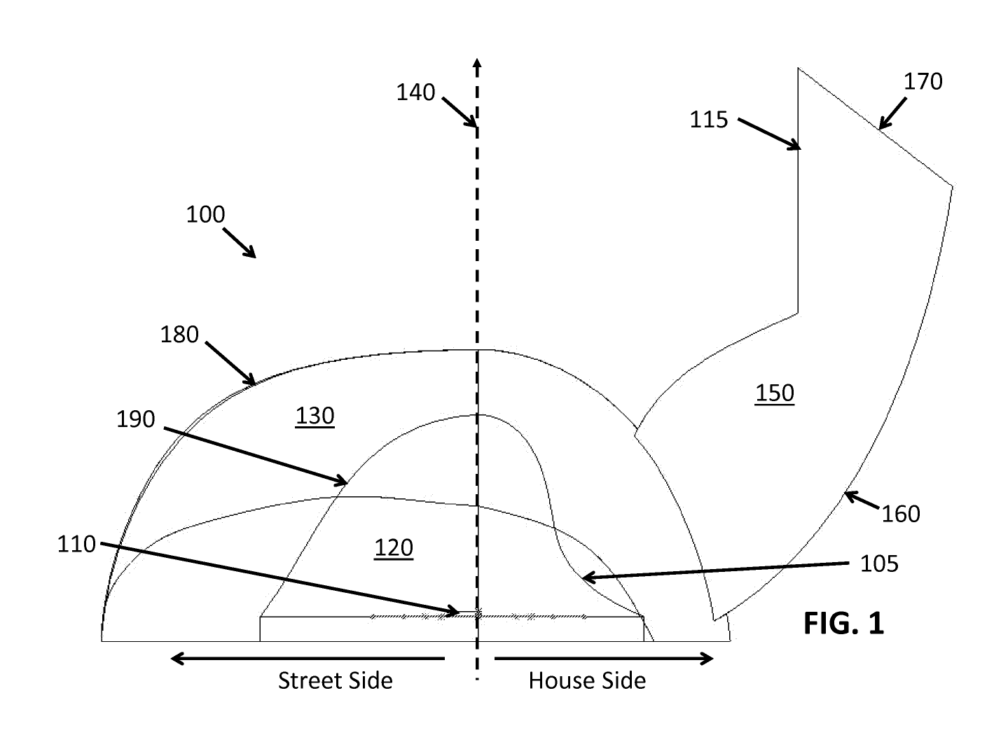

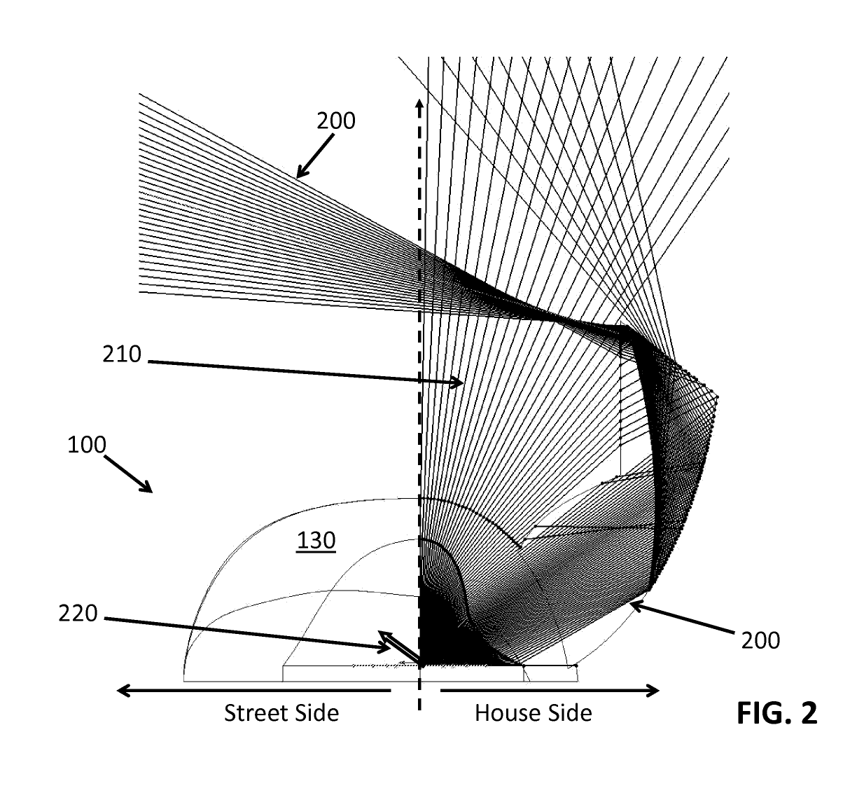

Turning now to FIGS. 1 and 2, these figures illustrate, in cross section, an exemplary illumination system 100 comprising a representative light emitting diode 110 and a representative optic 130 that manages light emitted by the light emitting diode 110 in accordance with certain embodiments of the present technology. FIG. 2 includes representative ray traces.

In certain embodiments, the illumination system 100 can be or comprise a luminaire for street illumination. However, those of ordinary skill having benefit of this disclosure will appreciate that street illumination is but one of many applications that the present technology supports. The present technology can be applied in numerous lighting systems and illumination applications, including indoor and outdoor lighting, automobiles, general transportation lighting, and portable lights, to mention a few representative examples without limitation.

The light emitting diode 110 produces light 200, 210 that is headed house side, opposite from street side, and other light 220 that is headed street side. The optic 130 can redirect a substantial portion of the house side light 200, 210 towards the street, where higher illumination intensity is often desired.

The light emitting diode 110 can be solitary or part of a light emitting diode array that is mounted adjacent (i.e., underneath) the optic 130. In certain embodiments, the light emitting diode 110 may comprise an encapsulant that provides environmental protection to the light emitting diode's semiconductor materials and that emits the light that the light emitting diode 110 generates. In certain example embodiments, the encapsulant comprises material that encapsulates the light generating optical element of the light emitting diode 110, for example an optoelectronic semiconductor structure or feature on a substrate of the light emitting diode 110. In certain example embodiments of the invention, the light emitting diode 110 can project or protrude into a cavity 120 that the interior surface 190 of the optic 130 forms. In certain example embodiments, the light emitting diode 110 radiates light at highly diverse angles, for example providing a light distribution pattern that can be characterized, modeled, or approximated as Lambertian.

The illustrated light emitting diode 110 comprises an optical axis 140 associated with the pattern of light emitting from the light emitting diode 110 and/or associated with physical structure or mechanical features of the light emitting diode 110. The term “optical axis,” as used herein, generally refers to a reference line along which there is some degree of rotational or other symmetry in an optical system, or a reference line defining a path along which light propagates through a system. Such reference lines are often imaginary or intangible lines.

The cavity 120 comprises an inner surface 190 opposite an outer surface 180. Light 220 emitted from the light emitting diode 110 in the street side direction is incident upon the inner surface 190, passes through the optic 130, and passes through the outer surface 180. Such light 220 may be characterized by a solid angle or represented as a ray or a bundle of rays. Accordingly, the light 220 that is emitted from the light emitting diode 110 and headed street side continues heading street side after interacting with the optic 130. The inner surface 190 and the outer surface 180 cooperatively manipulate this light 220 with sequential refraction to produce a selected pattern, for example concentrating the light 220 downward or outward depending upon desired level of beam spread. In the illustrated embodiment, the light 220 sequentially encounters and is processed by two refractive interfaces of the optic 130, first as the light enters the optic 130, and second as the light exits the optic 130.

The light emitting diode 110 further emits a section of light 200 that is headed house side or away from the street. This section of light 200 is incident upon a convex surface 105 of the cavity 120 that forms a beam 200 within the optic 130. In the illustrated embodiment, the convex surface 105 projects, protrudes, or bulges into the cavity 120, which is typically filled with a gas such as air. In certain exemplary embodiments, the convex surface 105 can be characterized as a collimating lens or as a refractive feature that reduces light divergence. The term “collimating,” as used herein in the context of a lens or other optic, generally refers to a property of causing light to become more parallel that the light would otherwise be in the absence of the collimating lens or optic. Accordingly, a collimating lens may provide a degree of focusing.

The beam 200 propagates or travels through the optic 130 and into a projection 150 on the exterior surface 180 of the optic 130. The projection comprises two internally reflective surfaces 160, 170 that successively reflect the light 200, resulting in redirection across the optical axis 140 outside the optic 130. The redirected light 200 exits the optic 130 through the surface 115 headed in the street side direction. In various example embodiments, the surfaces 160, 170, and 115 may be flat or curved or a combination of flat and curved. For example, as shown in FIG. 1, surface 160 is curved while surface 170 is flat.

The reflective surfaces 170 and 160 are typically totally internally reflective as a result of the angle of light incidence exceeding the “critical angle” for total internal reflection. The reflective surfaces 170 and 160 are typically interfaces between solid, transparent optical material of the optic 130 and a surrounding gaseous medium such as air.

Those of ordinary skill in the art having benefit of this disclosure will appreciate that the term “critical angle,” as used herein, generally refers to a parameter for an optical system describing the angle of light incidence above which total internal reflection occurs. The terms “critical angle” and “total internal reflection,” as used herein, are believed to conform with terminology commonly recognized in the optics field.

The light emitting diode 110 further emits a section of light 210 that is headed house side less aggressively than the section of light 200, in other words more vertically. The optic 130 transmits that light 210 so that a controlled level of light is emitted towards the house side.

In certain exemplary embodiments, the optic 130 is a unitary optical element that comprises molded plastic material that is transparent. In certain exemplary embodiments, the optic 130 is a seamless unitary optical element. In certain exemplary embodiments, the optic 130 is formed of multiple transparent optical elements bonded, fused, glued, or otherwise joined together to form a unitary optical element that is void of air gaps yet made of multiple elements.

In certain exemplary embodiments, the optic 130 can be formed of an optical plastic such as poly-methyl-methacrylate (“PMMA”), polycarbonate, or an appropriate acrylic, to mention a few representative material options without limitation. In certain exemplary embodiments, the optic 130 can be formed of optical grade silicone and may be pliable and/or elastic, for example.

Technology for managing light emitted from a light emitting diode or other source has been described. From the description, it will be appreciated that an embodiment of the present technology overcomes the limitations of the prior art. Those skilled in the art will appreciate that the present technology is not limited to any specifically discussed application or implementation and that the embodiments described herein are illustrative and not restrictive. From the description of the exemplary embodiments, equivalents of the elements shown therein will suggest themselves to those skilled in the art, and ways of constructing other embodiments of the present technology will appear to practitioners of the art. Therefore, the scope of the present technology is to be limited only by the claims that follow.

1.-20. (canceled)

21. A lighting system comprising:
a light emitting diode;
an optic comprising:
a first surface defining a cavity oriented to receive light from the light emitting diode; and
a second surface that is oriented away from the first surface, the second surface comprising:
a first region that is disposed opposite the light emitting diode;
a second region that is disposed peripherally with respect to the light emitting diode and the first region; and
a projection that projects peripherally from the second region and that comprises one or more totally internally reflective surfaces.

22. The lighting system of claim 21, wherein the projection comprises an undercut region.

23. The lighting system of claim 21, wherein the light emitting diode comprises an optical axis, and
wherein the projection comprises a first section that extends peripherally and a second region that extends substantially parallel to the optical axis.

24. The lighting system of claim 21, wherein the light emitting diode comprises an optical axis, and
wherein the projection comprises:
a first section that extends from the second region at a first angle relative to the optical axis; and
a second section that extends from the first section at a second angle relative to the optical axis.

25. The lighting system of claim 24, wherein the first angle is greater than the second angle.

26. The lighting system of claim 21, wherein the projection comprises two totally internally reflective surfaces.

27. The lighting system of claim 21, wherein the first surface comprises a lens that protrudes into the cavity.

28. The lighting system of claim 21, wherein the first surface comprises a convex surface that is aligned with the projection.

29. An illumination system comprising:
a light emitting diode that comprises an optical axis; and
an optic that is intersected by the optical axis and that comprises:
an interior surface defining a cavity that is oriented to receive light emitted by the light emitting diode,
wherein the optical axis divides the cavity into a first side and a second side,
wherein the first side of the cavity is larger than the second side of the cavity,
wherein the interior surface comprises a convex surface that is disposed on the second side of the cavity; and
an exterior surface opposite the interior surface.

30. The illumination system of claim 29, wherein the convex surface protrudes into the cavity to form a lens that is positioned to receive a portion of light emitted into the second side of the cavity by the light emitting diode.

31. The illumination system of claim 29, wherein the optical axis further divides the optic into a first side and a second side, and
wherein the exterior surface comprises:
a first region through which the optical axis passes; and
a second region that is offset from the first region, that is disposed on the second side of the optic, and that comprises a projection.

32. The illumination system of claim 31, wherein the projection comprises:
a first portion that extends away from the optical axis; and
a second portion that extends along the optical axis.

33. The illumination system of claim 29, wherein the convex surface comprises a lens that is shaped to reduce divergence of light emitted by the light emitting diode and that is positioned to couple light into a projection, the projection extending peripherally from the exterior surface.

34. The illumination system of claim 29, wherein the first side comprises a street side, and wherein the second side comprises a house side.

35. The illumination system of claim 29, wherein the exterior surface comprises a projection that comprises two totally internally reflective surfaces.

36. The illumination system of claim 29, wherein the exterior surface comprises a projection, and
wherein a portion of the projection is disposed substantially parallel to the optical axis.

37. A lighting system comprising:
a light emitting diode that comprises an optical axis; and
an optic that comprises:
an interior surface forming a cavity oriented to receive light from the light emitting diode; and
an exterior surface that opposes the interior surface and that comprises:
a first region through which the optical axis passes;
a second region that is disposed peripherally relative to the first region; and
a projection that is located on one side of the optical axis, that projects from the second region, and that extends away from the optical axis.

38. The lighting system of claim 37, wherein the projection comprises a first portion and a second portion, the first portion disposed between the second portion and the light emitting diode,
wherein the first portion extends away from the optical axis, and
wherein the second portion extends along the optical axis.

39. The lighting system of claim 37, wherein the interior surface comprises a lens that is oriented to couple light into the projection.

40. The lighting system of claim 37, wherein the projection comprises two surfaces that are oriented to totally internally reflect light that is emitted by the light emitting diode in a house side direction and to project the totally internally reflected light across the optical axis in a street side direction.
